(19) United States
(12) Patent Application Publication
(10) Pub. No.: US 2025/0110302 A1
(43) Pub. Date: Apr. 3, 2025

(54) HIGH POWER LINE SYSTEM FOR HOLLOW CORE FIBER AND USES THEREOF

(71) Applicant: Microsoft Technology Licensing, LLC, Redmond, WA (US)

(72) Inventors: Denizcan BILLOR, Seattle, WA (US); Jamie Dorea GAUDETTE, Kirkland, WA (US); Yawei YIN, Redmond, WA (US); Binbin GUAN, Issaquah, WA (US)

(21) Appl. No.: 18/374,680

(22) Filed: Sep. 29, 2023

(51) Int. Cl. G02B 6/42; G02B 6/02

(52) U.S. Cl. CPC G02B 6/4296; G02B 6/02304; G02B 6/02328

(57) ABSTRACT

A system for transmitting a light signal between a first solid core optical fiber network and a hollow core fiber network includes a plurality of transponder-amplifiers, where each transponder-amplifier of the plurality of transponder-amplifiers comprises a transponder in optical communication with one of a power amplifier and a pre-amplifier. The plurality of transponder-amplifiers is in optical communication with the first solid core optical fiber network and is operative to receive a plurality of first light signals from the plurality of transponder amplifiers. A multiplexer located downstream of the plurality of transponder-amplifiers is operative to receive the plurality of first light signals. The multiplexer is operative to select between a plurality of first light signals and transmits at least one light signal of the plurality of first light signals to the hollow core fiber network.

### BACKGROUND

Long-haul, terrestrial optical fiber networks connect cities and countries throughout the world. These networks typically range from a few hundred to several thousand kilometers and have largely migrated to 100 G-based (100 Gbps) dense wavelength division multiplexing (DWDM) systems with 80 channels or more. Conventionally, optical fibers having a solid waveguiding core configured for the propagation of a single optical mode (single mode or SM fiber) or multiple optical modes (multimode or MM fiber) have been used. An example of a single or multimode fiber is a silica optical fiber that carries optical signals at a wavelength of about 1550 nm, where silica has its lowest loss so that signals can be propagated over long distances with the minimum attenuation. Optical fibers for carrying data signals can be packaged into cables including one or more fibers within an outer jacket that protects the fibers during deployment and use of the fibers.

Within metropolitan areas and across wide area networks (WANs), cloud service providers (CSPs) generally offer high bandwidths with near-perfect service availability and appropriate latencies to meet customer demands for diverse types of data including enterprise cloud applications and email, voice over internet protocol (VOIP), streaming video, internet of things (IoT), search and cloud storage. Data centers are distributed through a metropolitan area interconnecting them with optical transport systems. A grouping of these data centers within a metropolitan region is referred to as a metro region or a metro ring.

One of the deficiencies of this conventional network system is that it is power-limited. Since all input signals are amplified by a single amplifier prior to being transmitted to a network, the power capabilities of the amplifier determines the ability of the network to transmit data. It also determines the network size since amplifiers that have greater power capabilities can transmit light signals over larger terrestrial distances.

Another deficiency of the network system is that the breakdown of any active component (such as a line amplifier or a pre-amplifier) can cause a large scale system breakdown in the entire network because each amplifier function as gateways to the entire network system. The breakdown of any single active component can therefore have a large “blast radius” (e.g., a large number of customers who are affected by the breakdown). For example, a breakdown of a single active component may temporarily render inoperable the network in a large city.

### SUMMARY

In an embodiment, a system for transmitting a light signal between a first solid core optical fiber network and a hollow core fiber network includes a plurality of transponder-amplifiers, where each transponder-amplifier of the plurality of transponder-amplifiers comprises a transponder in optical communication with one of a power amplifier and a pre-amplifier. The plurality of transponder-amplifiers is in optical communication with the first solid core optical fiber network and is operative to receive a plurality of first light signals from the plurality of transponder amplifiers. A multiplexer located downstream of the plurality of transponder-amplifiers is operative to receive the plurality of first light signals. The multiplexer is operative to select between a plurality of first light signals and transmits at least one light signal of the plurality of first light signals to the hollow core fiber network.

In another embodiment, a method for transmitting light signals between a solid core optical fiber network and a hollow core fiber network includes transmitting a plurality of first light signals from the solid core optical fiber network to a plurality of transponder-amplifiers. Each transponder-amplifier of the plurality of transponder-amplifiers comprises a transponder in optical communication with a power amplifier and a pre-amplifier. The plurality of first light signals are boosted using the power amplifier. A multiplexer located downstream of the plurality of transponder-amplifiers selects between the plurality of first light signals received from the plurality of transponder-amplifiers and transmits at least one light signal from the plurality of first light signals to the hollow core fiber network.

### BRIEF DECRIPTION OF THE FIGURES

FIG. 1 is a schematic depiction of a conventional transceiving amplifier that is in optical communication with a hollow core fiber on the transmitter-side of the amplifier and with a hollow core fiber on the receiver-side of the amplifier;

FIG. 2 is a depiction of a network system that employs a conventional amplifier of the FIG. 1;

FIG. 3 is an exemplary depiction of a network system that contains distributed line amplification and pre-amplification in conjunction with a transponder; and

FIG. 4 is an exemplary depiction of a multiplexer of the FIG. 3 where the line amplifier and pre-amplifier are excluded from the design.

### DETAILED DESCRIPTION

Disclosed herein a system that comprises a multiplexer-demultiplexer (hereinafter “multiplexer”) that is in optical communication with a transponder, where the transponder is integrated with active amplifying components. These active components are removed from individual conventional amplifiers that function as gateways to an entire network and instead are redistributed and integrated with individual transponders to form a transponder-amplifier combination (hereinafter transponder-amplifier). The transponder-amplifier is used to transmit signals from a solid core fiber network to a hollow core fiber network. The distribution and integration of these active amplifying components with individual transponders (to form transponder-amplifiers) increases reliability and robustness of the network by reducing the probability that breakdown of a single active component will lead to inoperability of the entire network.

This redistribution results in a dispersion of such breakdown-susceptible active components in the system. The breakdown of a single line amplifier or pre-amplifier therefore results in the breakdown of only that particular transponder and does not result in rendering an entire network temporarily inoperable. The “blast radius” (i.e., the number of customers affected by the change) is therefore reduced since only that portion of the network is impeded. The remainder of the network can continue to function unimpeded by the breakdown.

In addition, the transponder-amplifier combination can use different types of amplifiers for different circuits. Since a plurality of amplifiers can be used, amplifier saturation can be minimized and overall system power can be increased. Saturated output power is the maximum output power that can be attained from an amplifier.

As noted above, transponder-amplifier combination is used to facilitate data transmission from a solid core fiber network to a hollow core fiber network. Hollow core fibers provide an alternative to conventional solid core fibers by guiding light in air instead of glass. This enables data transmission at near-vacuum light speeds, higher optical powers over broader optical bandwidths with relative freedom from issues such as nonlinear and thermo-optic effects that can affect optical waves travelling in a solid. Hollow core optical fiber also delivers lower latency at longer distances with fewer repeaters than solid core optical fiber.

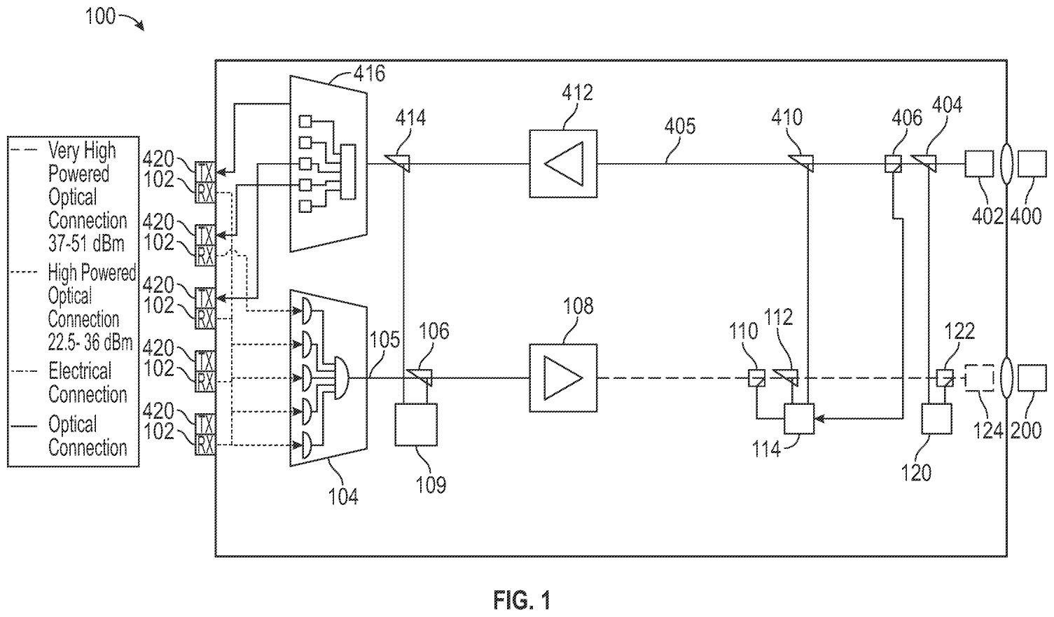

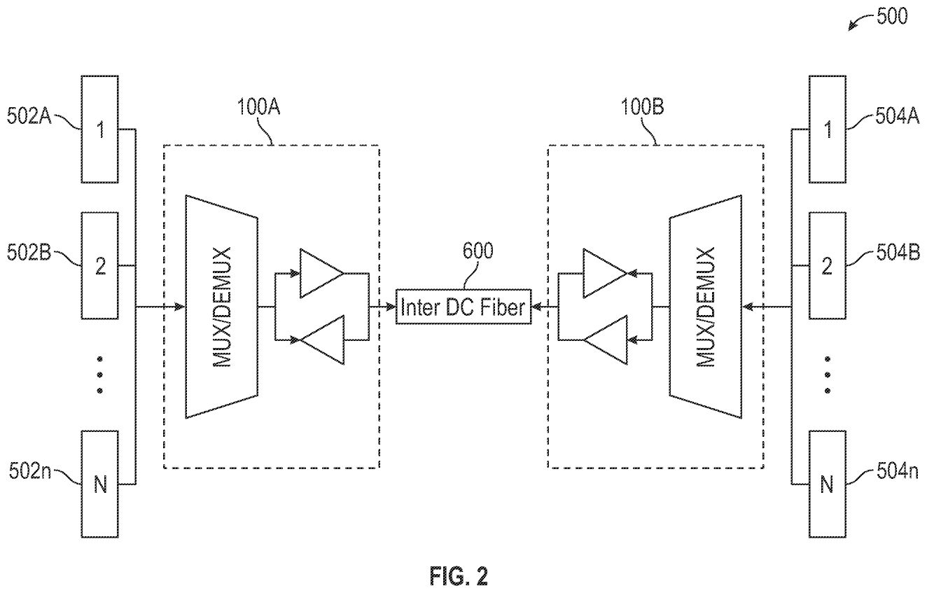

While hollow core fibers offer significant advantages over solid core fibers, these advantages are yet to be leveraged because the remainder of the existing infrastructure for data transmission is still based on solid core fibers. An example of this may be seen in the FIGS. 1 and 2. FIG. 1 is a schematic depiction of a conventional existing transceiving amplifier 100 that is in optical communication with a hollow core fiber 200 on the transmitter-side of the amplifier 100 and with a hollow core fiber 400 on the receiver-side of the amplifier 100. FIG. 2 is an exemplary depiction of a network system 500 that uses the conventional amplifier 100 of FIG. 1. Both hollow core fibers 200 and 400 are in optical communication with a hollow core fiber network (not shown).

The conventional amplifier 100 transmits data from a plurality of solid core optical fibers (not shown) to the hollow core fiber 200 on the transmitter-side and transmits data from the hollow core fiber 400 to the plurality of solid core optical fibers (not shown) on the receiver-side. The transmitter-side of the amplifier 100 comprises a plurality of input connectors 102 that are operative to contact a plurality of solid core optical fibers (not shown) that transmit data in the form of light signals to the hollow core fiber 200. The receiver-side of the amplifier transmits data from the hollow core fiber 400 to a plurality of output receiver connectors 420 that are in communication with the plurality of solid core optical fibers.

The transmitter-side of the amplifier 100 comprises a plurality of input connectors 102 that are operative to contact a plurality of solid core optical fibers (not shown) that transmit data in the form of light signals to a multiplexer 104. The multiplexer 104 lies upstream of a first beam splitter 106 that is in optical communication with an optical channel monitor (OCM) 109. The multiplexer 104 is in optical communication with the plurality of input connectors 102 and uses wavelength division multiplexing (WDM) to select between the plurality of inputs received from the plurality of solid core fibers that contact the plurality of input connectors 102. WDM comprises multiplexing a number of light signals onto a first single optical fiber 105 by using different wavelengths (i.e., colors) of laser light.

Light extracted by the beam splitter 106 from the first single optical fiber 105 permits the optical channel monitor 109 to measure data on optical transmission signals. An optical line amplifier 108 located downstream of the beam splitter amplifies the light signals to 37 to 51 dBm. The line amplifier is an erbium-doped fiber amplifier (EDFA). The erbium-doped fiber amplifier may be optically coupled with two laser diodes (LDs) (not shown) that provide the pump power for laser amplification via stimulated emission.

Located downstream of the optical line amplifier 108 is an optical time-domain reflectometer (OTDR) 114 that communicates with the first single optical fiber 105 via coupler 110 and beam splitter 112. The OTDR measures the backscattered light from the fiber to identify any losses or failures in the fiber network. Located downstream of the OTDR is an optical supervisory channel (OSC) 120 that communicates with first single optical fiber 105 via an optical coupler 122. The OSC provides a continuous monitoring function that allows for real-time supervision of the amplifier's performance. The first single optical fiber 105 is in optical communication with an output connector 124, which communicates with the hollow core optical fiber 200.

On the receiver-side of the amplifier 100, the hollow core fiber 400 contacts an input connector 402 which contacts a second single optical fiber 405. Located downstream of the input connector 402 is a beam splitter 404 that is in optical communication with the OSC 120, an optical coupler 406 and beam splitter 410 that are in optical communication with the OTDR 114, and a pre-amplifier 412 that lies downstream of all beam splitters 404, 408 and 410. The pre-amplifier 412 is placed just upstream of the demultiplexer 416, such that sufficient optical power will be received by the demultiplexer 416 and transmitted to the plurality of output receiver connectors 420. The demultiplexer 416 takes the input light signal from the second single optical fiber 405 and then switches it to any one of a number of individual output lines one at a time. The demultiplexer 416 can convert a serial light signal received from the pre-amplifier 412 to a parallel data stream where each data stream can be directed to each of the solid core fibers in the plurality of solid core optical fibers that are in contact with the plurality of output receiver connectors 420.

There are a number of deficiencies associated with this method of data transmission exemplified by the amplifier 100 of the FIG. 1. These are enumerated with respect to the FIG. 2. FIG. 2 is a depiction of a network system 500 that employs the amplifier 100 of the FIG. 1. A plurality of transponders 502A, 502B, . . . , 502n, and 504A, 504B, . . . , 504n are operative to transmit and receive light signals via amplifiers 100A, 100B and a hollow core fiber network 600. “n” is an integer. The amplifiers 100A and 100B lie downstream of the plurality of transponders 502A, 502B, . . . , 502n when these transponders are transmitting light signals and upstream of the plurality of transponders 504A, 504B, . . . , 504n when these transponders are receiving light signals. Similarly, the amplifiers 100A and 100B lie upstream of the plurality of transponders 502A, 502B, . . . , 502n when these transponders are receiving light signals and downstream of the plurality of transponders 504A, 504B, . . . , 504n when these transponders are transmitting light signals.

The amplifiers 100A and 100B are each of the amplifier design depicted in the FIG. 1 and contain a multiplexer, a demultiplexer, a line amplifier and a pre-amplifier as described above. As may be seen in the FIG. 2, each amplifier 100A and 100B functions as a gateway to the entire network system 500.

One of the deficiencies of this conventional network system 500 is that it is power-limited. Since all input signals are amplified by a single amplifier (either 100A or 100B) prior to being transmitted to the hollow core fiber network 600, the power capabilities of the amplifier determine the ability of the network to transmit data. The power capabilities of each amplifier also determines the network size since amplifiers that have greater power capabilities can transmit light signals over larger terrestrial distances.

Another deficiency of the network system 500 is that the breakdown of any active component (such as a line amplifier or a pre-amplifier) in a single amplifier (either 100A or 100B) can cause a large scale system breakdown in the entire hollow core fiber network 600 because each amplifier 100A and 100B both function as gateways to the entire network system. The breakdown of any single active component in any single amplifier can therefore have a large “blast radius” (e.g., a large number of customers who are affected by the breakdown). For example, a breakdown of a component in any one of the amplifiers 100A or 100B may temporarily render inoperable the network in a large city. This is undesirable.

One solution to this problem is to have a redundant back-up network with redundant amplifiers. This is not however, a cost effective solution.

It is therefore desirable to use alternative transponder and amplifier designs that are not dependent upon the continued long-term functioning of single active components in these devices.

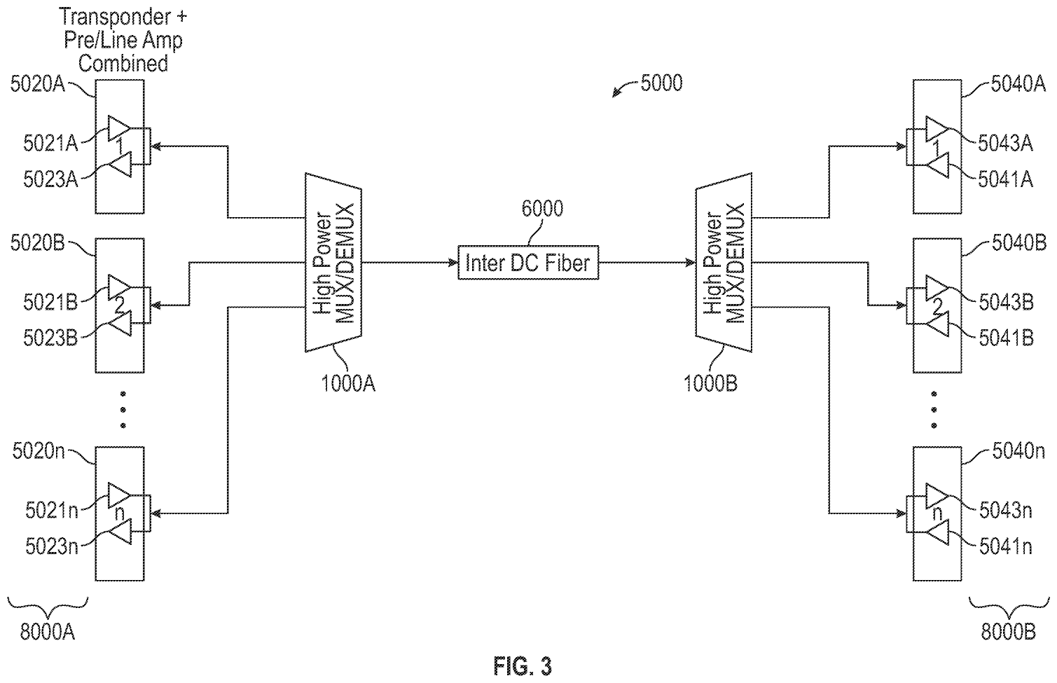

FIG. 3 is a depiction of a system 5000 where the inline amplifier and the pre-amplifier that is typically present in an amplifier (such as that depicted in the FIG. 1) are removed from the amplifier and redistributed and combined with a plurality of transponders to form transponder-amplifiers 5020A, 5020B, . . . , 5020n that are disposed upstream of the multiplexer/demultiplexer 1000A (hereinafter mux/demux 1000A) when transmitting a light signal from a first solid core optical fiber network 8000A to a hollow core fiber network 6000. Conversely, a plurality of transponder-amplifiers 5040A, 5040B, . . . , 5040n are disposed downstream of the multiplexer/demultiplexer 1000B (hereinafter mux/demux 1000B) when transmitting a light signal from the hollow core fiber network 6000 to a second solid core optical fiber network 8000B. Each transponder-amplifier in the plurality of transponder-amplifiers operates independently of another. It is to be noted that the term multiplexer encompasses a demultiplexer and vice versa. Thus the multiplexer 1000A also functions as a demultiplexer for light signals being transmitted from the hollow core fiber network to either the first or second solid core optical fiber networks 8000A, 8000B. The same logic applies to the demultiplexer 1000B; it can also function as a multiplexer for light signals travelling in the opposite direction.

As a result of this new arrangement, the traditional amplifier of the FIGS. 1 and 2 now functions primarily as a multiplexer when transmitting a light signal from a first solid core optical fiber network 8000A to a hollow core fiber network 6000 and primarily as a demultiplexer when transmitting a light signal from the hollow core fiber network 6000 to a second solid core optical fiber network 8000B. There are no amplifiers used downstream of the multiplexer and upstream of the hollow core fiber 6000.

The functioning of the system 5000 in the FIG. 3 will now be detailed. A plurality of first light signals from the first solid core optical fiber network 8000A are received at the first plurality of transponder-amplifiers 5020A, 5020B, . . . , 5020n located at one end of the hollow core fiber network 6000. The plurality of first light signals received at the first plurality of transponder-amplifiers 5020A, 5020B, . . . , 5020n are amplified to a desired power prior to being transmitted to a first mux/demux 1000A that is in optical communication with the hollow core fiber network 6000. The opposing end of the hollow core fiber network 6000 is in optical communication with the second plurality of transponder-amplifiers 5040A, 5040B, . . . , 5040n via a second mux/demux 1000B. The light signal received by the second mux/demux 1000B is demultiplexed into a second plurality of light signals which are transmitted to the second plurality of transponder-amplifiers 5040A, 5040B, . . . , 5040n. The second plurality of transponder-amplifiers 5040A, 5040B, . . . , 5040n amplify the power of the respective light signals to a value required for transmission through the second solid core optical fiber network 8000B.

As noted above, each transponder-amplifier of the plurality of transponder-amplifiers comprises a transponder in optical communication with a power amplifier and a pre-amplifier. As seen in the FIG. 3, each transponder-amplifier 5020A, 5020B, . . . , 5020n, 5040A, 5040B, . . . , 5040n, comprises a power amplifier and a pre-amplifier integrated with a transponder. For example, transponder-amplifier 5020A contains a power amplifier 5021A and pre-amplifier 5023A (integrated with a first transponder), while transponder-amplifier 5020B contains a power amplifier 5021B and pre-amplifier 5023B (integrated with a second transponder), and so on. While the term power amplifier is used to refer to amplifiers that boost the light signal that is supplied to the multiplexer, these particular amplifiers can also be line amplifiers that are not used traditionally as power amplifiers. The term power amplifier as used herein encompasses any amplifier that boosts a light signal that is supplied to the multiplexer and can comprise traditional power amplifiers as well as line amplifiers such as EDFA's.

The power amplifiers 5021A, 5021B, . . . , 5021n are operative to increase the power of the plurality of the first light signals that arrive at the transponder-amplifiers 5020A, 5020B, . . . , 5020n, via a router (not shown) from the the first solid core optical fiber network 8000A. Each transponder-amplifier accepts input in the form of a standard single-mode or multimode laser pulse. The input can come from different physical media and different protocols and traffic types. In an embodiment, the power amplifiers 5021A, 5021B, . . . , 5021n are booster amplifiers that boost the strength of the optical signal as it leaves the respective transponder-amplifiers 5020A, 5020B, . . . , 5020n to proceed to the mux/demux 1000A.

The wavelength of the transponder-amplifier input light signal is mapped to a WDM or DWDM wavelength by the transponder portion of the transponder-amplifier. The optical transponder portion of the transponder-amplifier extends the transmission distance by converting the wavelengths and amplifying the light signal. It automatically receives, amplifies and then retransmits a signal on a different wavelength without changing the data/signal content.

WDM or DWDM wavelengths from the plurality of transponder-amplifiers 5020A, 5020B, . . . , 5020n are multiplexed by mux/demux 1000A to form a light signal which is launched into the hollow core fiber 6000. The same procedure occurs in the transponder-amplifiers 5040A, 5040B, . . . , 5040n upon receiving a light signal from the second open network (i.e., the second solid core optical fiber network 8000B) that is to transmitted to the hollow core fiber 6000 via demultiplexer 1000B. The first and second solid core optical fiber networks 8000A and 8000B generally contain client side equipment.

The light signal from the hollow core fiber 6000 is received by the mux/demux 1000B, where it is demultiplexed into a second plurality of light signals that are then transmitted to the second plurality of transponder-amplifiers 5040A, 5040B, . . . , 5040n. The preamplifiers 5043A, 5043B, . . . , 5043n amplify the power of the second plurality of light signals to values required for transmission through the second solid core optical fiber network 8000B.

The system 5000 functions in the same manner for light signals that are to be transmitted in the opposite direction, i.e., from the second solid core optical fiber network 8000B to the first solid core optical fiber network 8000A via hollow core fiber network 6000. The plurality of light signals received from the second solid core optical fiber network 8000B are first amplified by power amplifiers 5041A, 5041B, . . . , 5041n (contained in the second plurality of transponder-amplifiers 5040A, 5040B, . . . , 5040n) prior to being multiplexed by mux/demux 1000B. The light signal emanating from the mux/demux 1000B is transmitted through the hollow core fiber network 6000 to mux/demux 1000A, where it is demultiplexed into a plurality of light signals that are amplified in pre-amplifiers 5023A, 5023B, . . . , 5023n (contained in the first plurality of transponder-amplifiers 5020A, 5020B, . . . , 5020n). The preamplifiers 5023A, 5023B, . . . , 5023n amplify the power of the plurality of light signals to values required for transmission through the first solid core optical fiber network 8000A.

Pre-amplifiers 5023A, 5023B, . . . , 5023n present in the respective transponder-amplifiers boost the signal after the transponder portion of the transponder-amplifier maps the wavelengths to the desired output type and transmits it to the first open network 8000A. The same procedure occurs in the transponder-amplifiers 5040A, 5040B, . . . , 5040n when light signals are to be transmitted to the second open network 8000B from the hollow core fiber 6000.

The amplifiers contained in each of the transponder-amplifiers will now be described in detail. In an embodiment, each transponder-amplifier 5020A, 5020B, . . . , 5020n, 5040A, 5040B, . . . , 5040n, can contain power amplifiers or pre-amplifiers that are the same as each other (in terms of power amplification capabilities) or different from each other. In other words, the power amplifiers and pre-amplifiers can all have the same power rating or different power ratings. In an embodiment, some of the power amplifiers and some of the pre-amplifiers can be the same as each other while the remainder can be different from each other. The power amplifiers can be booster amplifiers, line amplifiers or cascaded line amplifiers depending upon the transponder-amplifier design. The power amplifiers can be Raman amplifiers, semiconductor optical amplifiers, tapered amplifiers, optical parametric amplifiers, regenerative amplifiers, ultrafast amplifiers, master oscillator power amplifiers, chirped-pulse amplifiers, divided-pulse amplifiers, line amplifiers that include erbium (Er)-, ytterbium (Yb)-, and praseodymium (Pr)-doped fiber amplifiers, or a combination thereof.

In an embodiment, if different amplifiers are deployed in the different transponder-amplifiers of the system 5000, then individual light signals received in the different transponder-amplifiers can be amplified by different mechanisms to different power levels. For example, a first light signal from the plurality of first light signals in a first transponder-amplifier can be amplified by a different mechanism and to a different power level than a second light signal from the plurality of first light signals in a second transponder-amplifier of plurality of transponder-amplifiers.

Since the system 5000 of the FIG. 3 can contain a plurality of power amplifiers instead of a single line amplifier (such as that depicted in the FIGS. 1 and 2), the overall system power can be increased drastically over conventional amplifiers that contain a single line amplifier such as an EDFA. Since a hollow core fiber can transmit higher powered light signals (as compared with a solid core fiber) it can be surmised that each light signal can be launched from the respective transponder-amplifier at high power levels greater than 37 dBm, preferably 37 to 51 dBm. In other words, light signals can be launched and transmitted at a much higher power than systems that use centralized amplification (such as that depicted in FIGS. 1 and 2) and the hollow core fiber can handle this higher launch power.

Pre-amplifiers used in the transponder-amplifiers boost the signal to match the receiving first and second solid core optical fiber networks 8000A and 8000B. Optical preamplifiers are commonly used to improve the receiver sensitivity by preamplifying the signal before it reaches the first and second solid core optical fiber networks 8000A and 8000B. The plurality of preamplifiers (in the plurality of transponder-amplifiers) can be the same as each other (in terms of power amplification capabilities) or can be different from each other.

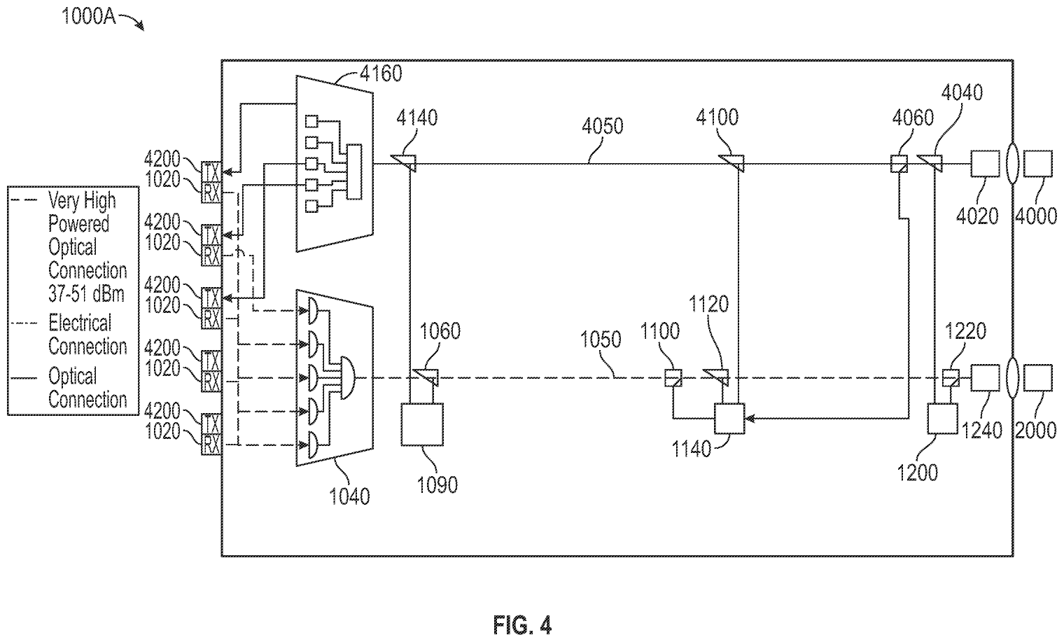

The use of a distributed system such as that depicted in the FIG. 3 results in an increasing of availability of fiber paths by at least 40%, preferably at least 50%. In other words, if the active components such as line amplifiers (See FIGS. 1 and 2.) are eliminated from the amplifiers thus reducing these amplifiers to just multiplexers (as detailed in the FIG. 4 below), the path availability of the system becomes equal to that of just the fiber. At an availability of 0.995 per device (such as the amplifier of the FIG. 1) the availability of the path goes from 94% to 97% reducing the overall downtime by an amount of 10% to 50%. It is to be noted that since the amplifiers are integrated into the transponders, there are preferably no amplifiers located downstream of the mux/demux (1000A, 1000B) and upstream of the hollow core optical fiber network 6000.

FIG. 4 is a depiction of the exemplary multiplexer-demultiplexer mux/demux 1000A that is devoid of active components such as the line-amplifier and pre-amplifier of the FIG. 1. As noted above, the active components are removed from the multiplexer 1000A and are merged with the transponder to form the transponder- amplifier depicted and described in the FIG. 3. FIG. 4 therefore represents the multiplexer 1000A of the FIG. 3 since it is devoid of amplification capabilities, those having been transferred to the transponder.

FIG. 4 is a schematic depiction of the mux/demux 1000A (or the mux/demux 1000B) that is in optical communication with a hollow core fiber 2000 on the transmitter-side of the mux/demux 1000A and with a hollow core fiber 4000 on the receiver-side of the mux/demux 1000A. Both hollow core fibers 2000 and 4000 are in optical communication with a hollow core fiber network (not shown).

The mux/demux 1000A transmits data in the form of light signal from a plurality of solid core optical fibers (not shown) to the hollow core fiber 2000 on the transmitter-side and transmits data from the hollow core fiber 4000 to the plurality of solid core optical fibers (not shown) on the receiver-side.

The solid core fiber network (not shown) that lies upstream of the mux/demux 1000A typically comprises a router and the plurality of transponder-amplifiers 5020A, 5020B, . . . , 5020n, 5040A, 5040B, . . . , 5040n of the FIG. 3 (both of which are not shown in the FIG. 4). A data stream comes in via the router and is input into the transponder-amplifier, which maps the signal to a WDM or DWDM wavelength and sends it to the high powered multiplexer 1040 via a plurality of input connectors 1020 (detailed below) to consolidate the optical signal.

The high powered multiplexer 1040 is operative to receive light signals at higher power levels of 37 to 51 dBm. Since the mux/demux 1000A of the FIG. 4 receives a boosted input light signal from the plurality of transponder-amplifiers 5020A, 5020B, . . . , 5020n of FIG. 3, it receives input signal power at a higher power level of greater than 37 dBm, preferably 37 to 51 dBm. This can be contrasted with the prior art amplifier 100 of the FIG. 1, where the input signal power is received at a power level of 22 to 36 dBm and boosted to 37 to 51 dBm along line 105 by line amplifier 108. The increase in the input light signal power level is therefore greater than 40%, preferably greater than 50% when compared with a traditional amplifier that has a line-amplifier.

The transmitter-side of the mux/demux 1000A comprises a plurality of input connectors 1020 that are operative to contact a plurality of solid core optical fibers (not shown) that transmit data in the form of light signals to a multiplexer 1040. The multiplexer 1040 lies upstream of a first beam splitter 1060 that is in optical communication with an optical channel monitor (OCM) 1090. The multiplexer 1040 is in optical communication with the plurality of input connectors 1020 and uses WDM or DWDM to select between the plurality of inputs received from the plurality of solid core fibers that contact the plurality of input connectors 1020. The multiplexer 1040 transmits these light signals onto a first single optical fiber 1050 at a power level 37 to 51 dBm (the same power level it is received at) without any further amplification.

Light extracted by the beam splitter 1060 from the first single optical fiber 1050 permits the optical channel monitor 1090 to measure data on optical transmission signals. The optical channel monitor 1090 is a multi-channel dense wavelength division multiplexing (DWDM) integrated optical component designed for use in systems with up to 40 channels. In an embodiment, the optical channel monitor 1090 is an arrayed waveguide grating (AWG) based product with added functionality-optical detection. It may use a series of integrated photodetectors that sample each channel simultaneously. This allows measurement of power to be made in real time, enabling channels in long-haul point-to-point or a metro ring to be balanced by banks of electronic variable optical attenuators (EVOA). Since the optical channel monitor 1090 can monitor all DWDM channels simultaneously it can be used as an effective optical protection device, as any drop in signal strength can be detected, or simply as a monitor to allow network operators to keep track of which channels are in operation.

Located downstream of the beam splitter is an electronic variable optical attenuator (EVOA) 1110 that ensures that every transmission along first single optical fiber 1050 looks identical from a received power perspective. The first single optical fiber 1050 is in optical communication with an output connector 1240, which communicates with the hollow core optical fiber 2000.

An optical time-domain reflectometer (OTDR) 1140 that communicates with the first single optical fiber 1050 via coupler 1100 and beam splitter 1120. The OTDR measures the backscattered light from the fiber to identify any losses or failures in the first single optical fiber. Located downstream of the OTDR 1140 is an optical supervisory channel (OSC) 1200 that communicates with first single optical fiber 1050 via an optical coupler 1220. The OSC provides a continuous monitoring function that allows for real-time supervision of the mux/demux 1000A performance.

On the receiver-side of the mux/demux 1000A, the hollow core fiber 4000 contacts an input connector 4020 which contacts a second single optical fiber 4050. Located downstream of the input connector 4020 is a beam splitter 4040 that is in optical communication with the OSC 1200 and an optical coupler 4060 and beam splitter 4100 that are in optical communication with the OTDR 1140. The input light signal from the hollow core fiber 4000 is first filtered to remove any extraneous inputs obtained from other transmitter-side amplifiers. The demultiplexer 4160 takes the input light signal from the second single optical fiber 4050 and then switches it to any one of a number of individual output lines one at a time. The demultiplexer 4160 can convert a serial light signal received from the hollow core fiber 4000 to a parallel data stream where each data stream can be directed to each of the solid core fibers in the plurality of solid core optical fibers that are in contact with the plurality of output receiver connectors 4200.

The output received at the connectors 4200 is then fed to the plurality of transponder-amplifiers 5020A, 5020B, . . . , 5020n depicted in the FIG. 3, where the distributed pre-amplifiers boost the light signal power to match the receiving first and second solid core optical fiber networks 8000A and 8000B (also seen in FIG. 3).

The removal of amplification capabilities from a traditional optical amplifier and redistribution of these capabilities to the plurality of transponder-amplifiers detailed herein offers significant system advantages over those of traditional amplifiers. The failure of an active component such as a line amplifier or pre-amplifier no longer will render the entire network inoperable. The blast radius of a breakdown is thus reduced. Fewer customers will be affected.

Because amplification capabilities are distributed, amplifier saturation is mitigated. Launch power-the power of the light signal can be increased because a larger number of amplifiers are used without amplifier saturation. The overall system power is increased significantly over systems where such amplification capabilities are centralized. This can result in an increase in network size-the use of distributed amplification can result in larger metro-ring networks. In addition, overall system downtime is reduced by an amount of 10% to 50% over systems that used centralized amplification.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A system for transmitting a light signal between a first solid core optical fiber network and a hollow core fiber network comprising:
a plurality of transponder-amplifiers; where each transponder-amplifier of the plurality of transponder-amplifiers comprises a transponder in optical communication with one of a power amplifier and a pre-amplifier; where the plurality of transponder-amplifiers is in optical communication with the first solid core optical fiber network and is operative to receive a plurality of first light signals from the plurality of transponder amplifiers; and
a multiplexer located downstream of the plurality of transponder-amplifiers; where the multiplexer is operative to receive the plurality of first light signals; where the multiplexer is operative to select between a plurality of first light signals received from the plurality of transponder-amplifiers and transmits at least one light signal of the plurality of first light signals to the hollow core fiber network.

2. The system of claim 1, where each transponder-amplifier comprises both the power amplifier and the pre-amplifier.

3. The system of claim 1, where the power amplifier is operative to boost an input light signal received from the solid core optical fiber network to a power level of greater than 37 dBm.

4. The system of claim 1, where the pre-amplifier is operative boost the light signal received from the hollow core fiber network prior to transmitting it to the solid core optical fiber network.

5. The system of claim 4, further comprising a demultiplexer located upstream of the plurality of transponder-amplifiers; where the demultiplexer is operative to demultiplex the at least one light signal received from the hollow core fiber network and transmit it to the pre-amplifier contained in the plurality of transponder-amplifiers.

6. The system of claim 5, wherein the multiplexer and demultiplexer are devoid of amplifiers and pre-amplifiers.

7. The system of claim 5, where the demultiplexer is operative to transmit the light signal to one of plurality of pre-amplifiers contained in the plurality of transponder-amplifiers.

8. The system of claim 1, where each transponder-amplifier in the plurality of transponder-amplifiers operates independently of another.

9. The system of claim 5, where the multiplexer further comprises one of an optical domain time reflectometer, an optical supervisory channel and an optical channel monitor.

10. The system of claim 1, where at least one power amplifier of the plurality of transponder-amplifiers is different from another power amplifier in the plurality of transponder-amplifiers.

11. The system of claim 1, where at least one power amplifier of the plurality of transponder-amplifiers is operative to boost the light signal to a power level of 37 to 51 dBm.

12. The system of claim 1, where a system downtime is reduced by at least 10 to 50%, over a comparative system where the multiplexer contains a line amplifier.

13. A method for transmitting light signals between a solid core optical fiber network and a hollow core fiber network comprising:
transmitting a plurality of first light signals from the solid core optical fiber network to a plurality of transponder-amplifiers; where each transponder-amplifier of the plurality of transponder-amplifiers comprises a transponder in optical communication with a power amplifier and a pre-amplifier;
boosting the plurality of first light signals using the power amplifier;
selecting between the plurality of first light signals received from the plurality of transponder-amplifiers using a multiplexer located downstream of the plurality of transponder-amplifiers; and
transmitting at least one light signal from the plurality of first light signals to the hollow core fiber network.

14. The method of claim 13, further comprising demultiplexing a second plurality of light signals received from the hollow core fiber network and transmitting at least one light signal from the plurality of second light signals to the pre-amplifier; where the demultiplexer is located upstream of the plurality of transponder-amplifiers.

15. The method of claim 13, wherein no further amplification of the at least one light signal is performed after the multiplexing.

16. The method of claim 13, further comprising operating each transponder-amplifier in the plurality of transponder-amplifiers independently of another.

17. The method of claim 14, further comprising boosting the second light signal received via the pre-amplifier prior to transmitting it to the solid core optical fiber network.

18. The method of claim 13, further comprising boosting the first light signal using the power amplifier to a power level of greater than 37 dBm.

19. The method of claim 18, further comprising boosting the first light signal to a power level of 37 to 51 dBm.

20. The method of claim 13, further comprising amplifying a first light signal from the plurality of first light signals in a first transponder-amplifier of plurality of transponder-amplifiers and amplifying a second light signal from the plurality of first light signals in a second transponder-amplifier of plurality of transponder-amplifiers; where the amplifying of the first light signal is conducted differently from the amplifying of the second light signal.
